(19) United States
(12) Patent Application Publication
(10) Pub. No.: US 2024/0351641 A1
(43) Pub. Date: Oct. 24, 2024

(54) UNDERRIDE GUARD FOR A MOTOR VEHICLE, MOTOR VEHICLE AND METHOD FOR PRODUCING AN UNDERRIDE GUARD

(71) Applicant: AUDI AG, Ingolstadt (DE)

(72) Inventors: Florian ACHHAMMER, lngolstadt (DE); Carsten LORENZ, Reichertshofen (DE); Martin SCHÜSSLER, Kösching (DE); Oliver STOLL

(73) Assignee: AUDI AG, Ingolstadt (DE)

(21) Appl. No.: 18/639,015

(22) Filed: Apr. 18, 2024

(30) Foreign Application Priority Data
Apr. 20, 2023 (DE) 102023110108.0

(51) Int. Cl. B62D 25/20; B60L 3/00; B60L 53/12

(52) U.S. Cl. CPC B62D 25/2072; B60L 3/0046; B60L 53/12

(57) ABSTRACT

An underride guard for a motor vehicle for arrangement below a high-voltage battery of the motor vehicle. The underride guard is plate-shaped, has a first surface, at least one plastic layer and at least one electrical component arrangement which includes at least one associated electrical line. In particular, the at least one electrical line is arranged on a support and is embedded together with the support in the plastic layer or is arranged on the plastic layer.

### FIELD

The invention relates to an underride guard for a motor vehicle for arrangement below a high-voltage battery of the motor vehicle, wherein the underride guard is plate-shaped, has a first surface, at least one plastic layer and at least one electrical component arrangement which comprises at least one associated electrical line. Furthermore, the invention also relates to a motor vehicle and a method for producing an underride guard.

### BACKGROUND

Such an underride guard is arranged in its intended arrangement on a motor vehicle below a high-voltage battery included in the motor vehicle. Such a high-voltage battery can be located, for example, in an underbody region of the motor vehicle. The underride guard thus protects the high-voltage battery from below, for example against stone impacts or other objects hitting the motor vehicle from below.

Furthermore, it is also known from the prior art to integrate sensors into such an underride guard. For example, DE 10 2020 119 287 A1 describes a battery arrangement for a motor vehicle with a battery which has a battery housing and a plurality of battery cells, the battery cells being arranged in the battery housing, a protective plate which is arranged at least on one side of the battery, and a damage detection device which has a damage indicator means, the damage indicator means being arranged on the protective plate and embedded in the protective plate. The protective plate can be designed in multiple layers and the damage indicator means can be sandwiched between layers. The layers can be made from a plastic or fiber-reinforced plastic and from a structural foam. The damage indicator means can, for example, have a strain gauge, a distance sensor through which the distance to the battery can be detected and monitored, a chamber which is filled with a fluid which leaks detectably if the chamber is damaged and an electrically conductive element which can be severed by a penetrating element arranged on the battery. The damage indicator means can also have a plurality of electrically conductive elements spaced apart from one another in the thickness direction by electrically non-conductive insulation elements. This damage indicator means can detect damage to the protective plate and/or deformation of the protective plate.

### SUMMARY

The object of the present invention is to integrate functions into an underride guard of a motor vehicle in the most efficient way possible and to simplify production as much as possible.

This object is achieved by an underride guard, a motor vehicle and a method for producing an underride guard.

An underride guard for a motor vehicle for arrangement below a high-voltage battery of the motor vehicle is plate-shaped, has a first surface, at least one plastic layer and at least one electrical component arrangement which comprises at least one associated electrical line. The at least one electrical line is arranged on a support and embedded together with the support in the plastic layer, or the at least one electrical line is arranged on the plastic layer.

The arrangement of the at least one electrical line on a support simplifies handling during production and offers significantly more flexibility with regard to the design and arrangement options for the component arrangement. On the one hand, this makes embedding in the plastic layer easier, since the arrangement of the support and the electrical line arranged thereon can be inserted more easily into a tool, such as an injection molding tool, and the electrical lines do not have to be inserted and overmolded, for example as wires or the like. The risk of breakage or damage to the at least one electrical line is thus significantly reduced. It also enables the formation of significantly finer conductor track structures, which can be applied to the support in the form of at least one electrical line, for example like a printed circuit board. The support, which can generally be rigid or flexible, additionally stabilizes the at least one electrical line, which simplifies the subsequent manufacturing steps, and the arrangement of the at least one electrical line on the support is also very simple. For example, known methods for providing conductor tracks on a conductor track substrate or an optionally flexible printed circuit board or circuit board can be used to provide the at least one electrical line on the support. Above all, this procedure makes it possible to position the at least one electrical line on or in the underride guard independently of the component assigned to the line, for example an associated sensor the measurement signals of which are to be routed via this line. Such a sensor or measuring probe can, for example, be arranged on the surface of the underride guard provided by the plastic layer, for example in a recessed surface region, and the associated electrical line can be embedded in the plastic layer together with its support in a protected manner. On the other hand, components can also be integrated into the underride guard in a particularly advantageous manner, which components are designed with conductor tracks running on the surface of the underride guard or the first plastic layer. This in turn is based on the knowledge that, on the one hand, there are very great advantages in integrating sensors for monitoring the high-voltage battery into the underride guard, for which it is advantageous for detection and monitoring purposes not to be embedded in a plastic layer, but instead to be arranged on a surface of this plastic layer. Examples of this include liquid sensors to detect a liquid accumulating on the surface or a harmful gas sensor to detect a harmful gas leak from the energy storage. Furthermore, the knowledge is used that if the underride guard is formed with at least one plastic layer, as is the case here, this plastic layer can also be used as a circuit board substrate. Sensors and their electrical lines can optionally be arranged directly on the surface of the underride guard provided by the plastic layer as the support, or the support with the at least one electrical line can be arranged directly on top of the plastic layer. This advantageously also makes it possible to arrange larger sensors or measuring components or sensing probes, which are assigned to the at least one electrical line, also directly on the support, since the installation space is then not as limited upwards, namely perpendicularly to the support plane, as if the support with the at least one electrical line arranged thereon is embedded in the plastic layer.

Consequently, the invention makes it possible to integrate functions into an underride guard of a motor vehicle in a very efficient manner, thereby significantly simplifying production and significantly increasing flexibility in terms of arrangement and design options.

To apply the conductor tracks, for example, conventional etching processes for producing conductor tracks can be used or so-called printed electronics, that is, printing such conductor tracks using an electrically conductive ink. In some cases, certain sensor components can also be printed directly onto the circuit board substrate, which is provided by the support. The support can then be made, for example, from a conventional circuit board material. The support can be designed, for example, as a plastic film.

However, it is particularly advantageous according to a preferred embodiment of the invention that the support is provided as a substrate which comprises reinforcing fibers, preferably glass fibers, in particular as a reinforcing fiber fleece, for example as a glass fiber fleece. This in turn is based on the knowledge that the underride guard or the plastic layer covered by it is preferably designed as a fiber-reinforced plastic plate, which can thus provide the underride guard with a very high level of stability and robustness. If the support is made of a glass fiber fleece or a woven or interwoven glass fiber layer, the support can also function as a reinforcing layer of the fiber-reinforced plastic plate. In addition, the support with the at least one electrical line arranged thereon can be easily handled during the production of the fiber-reinforced plastic plate in the same way as other layers of reinforcing fibers integrated or to be integrated into the fiber-reinforced plastic plate.

The at least one electrical line can then be embroidered or woven, for example, onto the reinforcing fiber layer, namely the substrate with or made of the reinforcing fibers. This means that the electrical line can be integrated very easily and stably into the reinforcing fiber layer.

The reinforcing fiber layer or in general the support can also be designed to have a very large area and, for example, extend over a large part of the surface of the underride guard or almost the entire surface of the underride guard. Not only one electrical line can be integrated on the support, but numerous ones. This means that numerous components of the component arrangement can be integrated into the underride guard. A corresponding line arrangement or conductor track arrangement can be readily provided on the support.

According to a further embodiment of the invention, the plastic layer represents the support and is designed as a circuit board substrate and the at least one electrical line is applied in the form of at least one conductor track on the first surface of the underride guard provided by the at least one plastic layer.

The provision of a separate circuit board substrate or support can therefore be omitted. This means that weight and material can be saved and the manufacturing costs can also be reduced because additional work steps, such as mounting the circuit boards on the underride guard, can be omitted.

However, the provision of a separate support, which is applied to the first surface of the underride guard provided by the at least one plastic layer, simplifies the production or manufacture of the lines, since the underride guard and thus the plastic layer, which can extend over the entire underride guard, is very large. In order to integrate multiple electrical lines into the underride guard, for example, multiple supports can also be provided, on each of which at least one or more electrical lines are arranged and which are then arranged on the surface of the plastic layer or integrated therein. The supports can therefore be made significantly smaller in area than the plastic layer, which simplifies handling during production. Therefore, it represents a further advantageous embodiment of the invention that the at least one electrical line is applied together with the support formed separately from the plastic layer on the first surface of the underride guard provided by the at least one plastic layer.

Furthermore, the described variants, namely the integration of the at least one electrical line arranged on the support into the plastic layer, the arrangement of the at least one electrical line arranged on the support on the surface of the plastic layer formed separately from the support, and the arrangement of the at least one electrical line directly on the surface of the plastic layer, which then represents the support, can also be combined as desired for multiple electrical lines. For example, at least a first electrical line arranged on the support can be embedded in the plastic layer and/or at least a second electrical line arranged on the support can be arranged together with the support on the surface of the plastic layer formed separately from the support and/or at least a third electrical line can be arranged directly on the surface of the plastic layer, which then forms the support.

According to a further embodiment of the invention, the at least one electrical line is embedded in the at least one plastic layer as part of an induction charging coil and/or a heating device included in the component arrangement.

This embodiment of the invention is based on the knowledge that the design of the underride guard with at least one plastic layer allows not only sensors, but also other components to provide further functions to be integrated into the underride guard in a particularly space-saving, material-saving and weight-saving manner. In addition to the integration of components that only allow detection of damage to the underride guard or the high-voltage battery itself, on the one hand, for example, components or functions can also be integrated that are not intended for detection or monitoring purposes, such as an induction charging coil or a heating device. The electrical line can be part of the induction charging coil itself or the electrical line can represent such an induction charging coil. Using an external magnetic field, which is generated, for example, by a primary coil external to the vehicle, a charging current for charging the high-voltage battery can be induced into the induction charging coil, which functions as a secondary coil. Likewise, the electrical line can also be part of a heating device, for example a heating coil or a heating wire, which is laid within the plastic layer of the underride guard. The heating device serves to heat the high-voltage battery. This means that a heating device for heating the high-voltage battery can also advantageously be integrated into the underride guard.

This provides further advantageous options for efficiently using the underride guard to provide additional functions and also for integrating these functions into the underride guard in a particularly efficient and space-saving manner.

It can therefore be provided that such an electrical line, together with its support, is completely covered by the plastic layer of the underride guard, for example except for at least one connection for the line and/or a sensor. Based on the intended installation position of the underride guard, it is arranged below a high-voltage battery of the motor vehicle, in particular so that the first surface faces the high-voltage battery. The high-voltage battery of the motor vehicle can, for example, have a battery housing with battery cells accommodated therein. Such a battery housing can also include a housing base, for example. In this case, the underride guard is arranged below this housing base in relation to its intended installation position in the motor vehicle. The underride guard can also be mounted or attached to the underside of the high-voltage battery. At least in some regions, a space can be formed between the underride guard and the high-voltage battery. This can, for example, also be used as a gas discharge channel for removing harmful gases from this battery cell in the event of a thermal runaway of a battery cell, as will be explained in more detail later.

In principle, the underride guard can comprise a protective plate, which in turn has at least one plastic layer. This protective plate can also be made entirely of plastic, in particular of a fiber-reinforced plastic.

Therefore, it represents a further advantageous embodiment of the invention if the underride guard has a plate which provides the first surface of the underride guard and provides an opposite second surface, wherein the plate comprises the at least one plastic layer. The plastic layer and in particular the plate can be made of a fiber-reinforced plastic, in particular completely made of a fiber-reinforced plastic. The fact that this plate is made entirely of fiber-reinforced plastic should be understood to mean that the electrical components integrated into the plate, such as the heating device and/or the induction charging coil and/or other electrical lines, are not viewed as part of the plate.

In a further advantageous embodiment of the invention, the at least one plastic layer is designed as a fiber-reinforced plastic layer. This allows the stability of the plastic layer to be significantly increased. For example, layers of reinforcing fibers can be embedded in the plastic layer. However, reinforcing fibers can also be embedded in the plastic in the form of very short fiber snippets to reinforce the plastic.

The reinforcing fibers integrated into the plastic can be provided, for example, as carbon fibers and/or glass fibers and/or aramid fibers. If the at least one electrical line with the support is embedded in this fiber-reinforced plastic, the support with the at least one electrical line can be arranged between reinforcing fiber layers. The electrical line and its support can be embedded in the fiber-reinforced plastic in the course of an injection molding process and/or high-pressure intrusion process.

Based on the intended installation position of the underride guard in the motor vehicle, the first surface of the underride guard points in the direction of the high-voltage battery. The underride guard can also have a second surface opposite the first surface, which, based on the intended installation position of the motor vehicle, then faces a ground of the motor vehicle or is adjacent to the surroundings of the motor vehicle. The underride guard or the plate described thus separates the surroundings of the motor vehicle from the motor vehicle. If the electrical line is applied as a conductor track on the first surface of the underride guard, it is positioned on the motor vehicle side or high-voltage battery side on the underride guard. This means that the electrical line is not exposed to environmental influences. In addition, an electrically insulating coating can also be applied to the electrical line, which then also functions as a protective layer. This also makes it possible to easily integrate sensors into the underride guard that are suitable for monitoring the high-voltage battery and are positioned on the underride guard facing the high-voltage battery.

In an advantageous embodiment of the invention, the at least one electrical component arrangement comprises at least one sensor and the at least one conductor track represents a sensor line for conducting measurement signals from the sensor. The conductor track can then advantageously be used to route the measurement signals detected by the sensor to a specific connection point. Above all, it is very advantageous if the at least one sensor is designed to detect a parameter, a property and/or a defect of the high-voltage battery independently of damage and/or deformation of the underride guard. The sensor can be designed in such a way that a deformation and/or damage to the underride guard itself cannot be detected by means of the sensor. The sensor can, for example, be designed as a sensor for detecting a measurement variable assigned to the high-voltage battery or a malfunction associated with the high-voltage battery. The sensor can therefore, for example, detect damage or malfunction of the high-voltage battery or can be used to detect such a malfunction or damage, even if there is no damage or deformation of the underride guard. The sensor can be designed in such a way that deformation and/or damage to the underride guard itself cannot be detected by means of the sensor. This means that security can be significantly increased by increasing the scope of monitoring of a high-voltage battery, especially without requiring additional installation space.

In this case in particular, it is particularly advantageous if such a sensor is arranged on the first surface of the underride guard, which should therefore face the high-voltage battery. Therefore, it represents a further very advantageous embodiment of the invention if the sensor line is guided from the sensor to a connection point of the underride guard, in particular wherein the at least one sensor and/or the connection point are arranged on the first surface of the underride guard. It can also be provided that the at least one electrical line from the sensor to the connection point is also arranged on this first surface or is preferably completely covered together with its support by the plastic layer of the underride guard, for example except for the at least one connection to the connection point and/or a connection for the sensor. The sensor can also be arranged in a recess on the surface. As a result, it is better protected, the height can be reduced and the electrical contact with the associated sensor line embedded in the plastic layer, which is provided by the at least one electrical line, is therefore very simple.

The connection point can also optionally be arranged on the first surface of the underride guard. However, it can also be arranged on the support and embedded in the plastic layer. This means that the electrical circuit of such a sensor arrangement can be arranged completely in a protected region and can be easily integrated into the underride guard.

In a further advantageous embodiment of the invention, the underride guard has a measuring transducer which is arranged on the surface and which is electrically connected to the at least one connection point and is designed to detect the measurement signals provided by the at least one sensor. The measuring transducer can, for example, have an analog-to-digital converter. The measuring transducer can also be arranged in a recess on the surface of the underride guard. The measuring transducer can transform the received measurement signals and, for example, forward them to a control device connected to the underride guard. Such a control device does not necessarily have to be part of the underride guard. The measuring transducer can, for example, be connected to a connection plug on the underride guard, to which the measuring transducer can provide the converted signals. For example, the control device mentioned can be connected to this connector plug. However, it is also conceivable to forward the measurement signals provided by the sensors directly to such a control device. Such a control device can therefore also be connected directly to the connection point mentioned above. Optionally, such a control device can also be integrated into the underride guard and, for example, be arranged on the first surface of the first plate or the underride guard.

In a further advantageous embodiment of the invention, the at least one sensor represents at least one of the following: a temperature sensor, a humidity sensor and/or liquid sensor and a harmful gas sensor. A temperature sensor can be designed to detect a current temperature. This means that the region below the high-voltage battery can be monitored for a temperature increase, which, for example, suggests that a battery cell is in thermally runaway. By means of a moisture sensor and/or liquid sensor, for example, moisture or liquid can be detected on the first surface of the underride guard. This can, for example, indicate a leak in the high-voltage battery's cooling system. This can also indicate improper liquid penetration into this region between the high-voltage battery and the underride guard. A harmful gas sensor can be used to detect harmful gas escaping from a battery cell of the high-voltage battery. It is particularly advantageous if, for example, a gas discharge channel for discharging harmful gases escaping from cells is provided through a space between the underride guard and the high-voltage battery or at least part of this space is used as part of such a gas discharge channel. If such a harmful gas emerges from a cell, it can be directed into this space and thus be detected particularly quickly and reliably by the harmful gas sensor. Such sensors can be used to quickly and reliably detect particularly critical situations and events in connection with a high-voltage battery, such as thermal runaway of a battery cell and/or outgassing of a battery cell or a leak in the cooling system. If one of these events or anomalous behavior in general is detected, appropriate action can be taken.

Especially with the above-mentioned sensors, such as the temperature sensor, the moisture sensor or liquid sensor and the harmful gas sensor, it is very advantageous if these are not embedded in the plate of the underride guard, at least not completely, but are instead positioned on the first surface, since a complete embedding would prevent, reduce or impair the exercise of their functions. As already mentioned, the sensors can also be arranged in a recess on the first surface of the underride guard. Such a recess, which accordingly has an opening upwards, should also be considered part of the first surface of the underride guard.

Furthermore, it is preferred if the underride guard includes multiple such sensors. In particular, the underride guard can include all of the sensors mentioned in any combination and in particular multiple of the respective sensor types mentioned, thus for example multiple temperature sensors, multiple moisture and liquid sensors and multiple harmful gas sensors. These can be arranged distributed on the first surface of the underride guard. This makes it possible to monitor a large region of a high-voltage battery, which is also typically very large. Error cases that occur can not only be detected, but also localized, for example, depending on which of the sensors detected them and where these sensors are positioned in relation to the high-voltage battery. The redundancy of the sensors can also provide greater reliability in the detection of certain events. This also increases reliability in case of faults. An extended sensor arrangement can be provided in a particularly simple manner using the measures described above. In particular, virtually the entire plastic layer can easily serve as a very large, extended circuit board and/or circuit board substrate, on which the desired sensors in any arrangement as well as their wiring in the form of corresponding conductor tracks can be easily applied and/or can be embedded on their at least one support into the plastic layer. The provision of numerous sensors thus requires hardly any installation space or material and can therefore be implemented in a particularly compact and cost-effective manner.

According to a further advantageous embodiment of the invention, the underride guard has a deformation and/or intrusion sensor, to which the at least one electrical line or a further second electrical line is assigned, which is embedded in the at least one plastic layer, in particular together with the support. Such a deformation and/or intrusion sensor can be designed in a variety of ways. For example, a long electrical line can be embedded in a desired region to be monitored, for example in a winding shape, for example in a serpentine or meandering shape. Regions that are to be monitored separately for deformation and/or intrusion can be provided with separate third electrical lines. A measuring device can be connected to one end or to both ends of such a third line, which measuring device measures, for example, a resistance of the third electrical line. In the event of deformation and/or intrusion, this resistance changes to a greater or lesser extent. This means that a deformation and/or intrusion as well as the strength of the deformation and/or intrusion can be inferred. The laying of such a third electrical line can also be implemented particularly easily by embedding it in the plastic layer.

In general, the underride guard can not only have one plastic layer, but in principle also multiple plastic layers. For example, the underride guard can have a first plastic layer, which also provides the first surface of the underride guard, and a second plastic layer arranged below the first plastic layer. In this case, the at least one electrical line can be embedded, for example, in the first or second plastic layer. For example, a separate electrical line can also be arranged in both plastic layers in different regions of the underride guard. For example, if a heating device and/or an induction charging coil is also to be embedded in one of the plastic layers of the underride guard, the heating device and/or induction charging coil and/or further electrical lines, for example sensor lines, can be embedded in different layers. If the underride guard only has a single plastic layer, for example the plastic plate made of fiber-reinforced plastic described above, the individual electrical lines embedded in this plate, for example the one that represents an induction charging coil and/or a heating device, and that which is part of the deformation and/or intrusion sensor and/or of other sensors, can be arranged one above the other with respect to a first direction together with their respective supports, which is aligned essentially perpendicular to the first surface of the underride guard, and which, when installed in the intended position in a motor vehicle for example, corresponds to a vehicle vertical axis of the motor vehicle. The electrical line of an induction charging coil can then, for example, advantageously be arranged at the lowest point, that is to say closest to a second surface of the underride guard, which is opposite the first surface. The heating device can instead be arranged as close as possible to the first surface in order to be able to heat the high-voltage battery as efficiently as possible.

Furthermore, the invention also relates to a motor vehicle having an underride guard according to the invention or one of its embodiments.

The motor vehicle can also comprise the high-voltage battery described. This is then arranged accordingly with respect to a vehicle vertical axis above the underride guard. With regard to a vehicle longitudinal direction and a vehicle transverse direction, the underride guard can extend over the entire length and width of the high-voltage battery. The sensor arrangement or component arrangement described above can also be arranged over this entire region of the underride guard corresponding to a length and width of the high-voltage battery, be it on its first surface, which is arranged facing the high-voltage battery and/or integrated into the plastic layer of the underride guard.

Furthermore, the invention also relates to a method for producing an underride guard for a motor vehicle for arrangement below a high-voltage battery of the motor vehicle, wherein the underride guard is plate-shaped, with a first surface and with at least one plastic layer and is formed with at least one electrical component arrangement, which comprises at least an associated electrical line. The at least one electrical line is in particular arranged on a support and embedded together with the support in the plastic layer or arranged on the plastic layer.

The advantages described in relation to the underride guard according to the invention apply in the same way to the method according to the invention.

According to a further advantageous embodiment of the invention, the at least one conductor track is applied to the support by embroidering a support provided as a reinforcing fiber fleece with an electrically conductive fiber or an electrically conductive fiber bundle and/or by applying an electrically conductive coating and using an etching process on the coating for generating the at least one conductor track and/or by printing the surface of the support using an electrically conductive ink. This is also known as printed electronics. The application of the at least one conductor track can therefore be carried out by a subtractive process, namely the etching process, or by an additive process, such as embroidering and/or printing on the surface. If the support with the at least one electrical line should also be embedded in the plastic layer, this can be done, for example, using an injection molding process.

The invention also comprises developments of the method according to the invention, which have features as already described in the context of the developments of the underride guard according to the invention and the motor vehicle according to the invention. For this reason, the corresponding developments of the method according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of multiple of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic representation of a motor vehicle having an underride guard according to an exemplary embodiment of the invention; and

FIG. 2 shows a schematic and perspective illustration of an underride guard according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

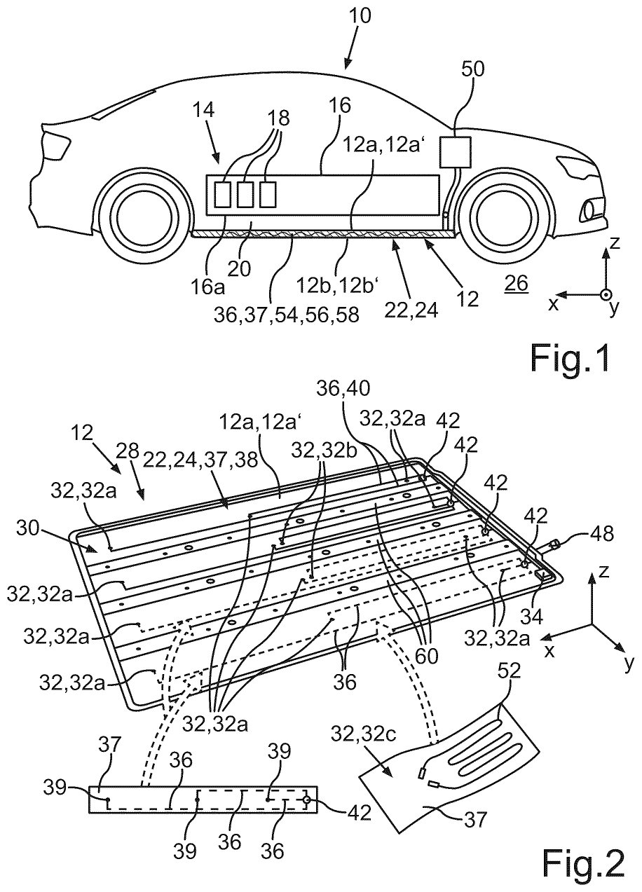

FIG. 1 shows a schematic illustration of a motor vehicle 10 having an underride guard 12 according to an exemplary embodiment of the invention. In addition, the motor vehicle 10 in this example includes a high-voltage battery 14, which is arranged above the underride guard 12 with respect to the z direction shown, which can be aligned, for example, parallel to a vehicle vertical axis of the motor vehicle 10. The high-voltage battery 14 can comprise, for example, a battery housing 16 with multiple battery cells 18 arranged therein. The battery cells can optionally be combined into battery modules. The battery cells can be formed as lithium-ion cells, for example. The battery housing 16 may include a housing base 16a that faces the underride guard 12. A space 20 can be formed between the housing base 16a and the underride guard 12, which space can be used, for example, partially as a gas discharge channel for removing harmful gases from cells 18 in the event of a thermal runaway of such cells 18. The underride guard 12 is designed in the form of a plate and, for example, has dimensions in the x and y directions, which preferably extend over an entire length and width of the high-voltage battery 14 in the x and y directions. This underride guard 12 can, for example, have a length in the x direction of two meters and a width in the y direction of, for example, 1.3 meters.

In this example, the underride guard 12 includes a plate 22, which is made of a fiber-reinforced plastic 24, for example. The underride guard 12 also has a first side 12a with a first surface 12a′, which faces the high-voltage battery 14, and a second side 12b, which is opposite in the z-direction, with a second surface 12b′, which faces a ground on which the motor vehicle 10 is located or faces an environment 26 of the motor vehicle 10. The underride guard 12 therefore protects the high-voltage battery 14 from below, for example from impacting stones or other objects impacting from below. In addition, a component arrangement 28 (see FIG. 2) can now advantageously be integrated into this underride guard 12, as will now be explained in more detail below in connection with FIG. 2.

FIG. 2 again shows a schematic and perspective representation of an underride guard 12 according to an exemplary embodiment of the invention, which can be designed in particular as already described in FIG. 1. FIG. 2 shows the underride guard 12 in a perspective view from obliquely above on its upper side 12a with the surface 12a ′. The underride guard 12 now includes the already mentioned component arrangement 28, which in this example includes a sensor arrangement 30 with multiple sensors 32. In this example, the sensor arrangement 30 has twelve combination sensors 32a, each of which can comprise a temperature sensor and a liquid sensor. In addition, the sensor arrangement 30 comprises two gas sensors 32b as further sensors 32 for detecting harmful gases. These sensors 32 are arranged on the first surface 12a of the fiber-reinforced plastic plate 22 of the underride guard 12, optionally in corresponding recesses on this first surface 12a. Furthermore, a measuring unit 34 in the form of a measuring transducer is arranged on the surface 12a′. The sensors 32 mentioned, which are arranged on the surface 12a′, are connected to this measuring unit 34 via respective electrical lines 36. For reasons of clarity, only some of these lines 36 are provided with a reference number.

Since the underride guard 12, in particular the plate 22 mentioned, is formed from a fiber-reinforced plastic and thus from an electrically insulating material, it is now advantageously possible to integrate the electrical lines 36 very advantageously into this underride guard 12. The lines 36 can be arranged on one hand on a support 37 and integrated or embedded together with the support 37 in the plastic layer 24 of the plate 22. For better illustration, these lines 36 arranged on the support 37 are shown separately again in FIG. 2 in a state not yet embedded in the plastic layer 24 and are shown with dashed lined in the embedded state together with the support 37 in the plastic layer 24. The support can be provided, for example, by a glass fiber fleece on which the electrical lines 36 are applied, for example embroidered. A connection point 42 for connection to the measuring unit 34 may also be located on the support 37, as well as corresponding contact points 39 for electrical contact with the corresponding sensors 32, which are located on the surface 12a′.

In addition, it is possible to use the plate 22 or the plastic layer 24 provided by it at the same time as a circuit board substrate 38, that is to say as a support 37, for the electrical lines 36 mentioned, or to apply the support 27 with the electrical lines 36, which is manufactured separately from the plastic layer 24 on the plastic layer. These can advantageously be applied in the form of conductor tracks 40 directly to the plate 22 or its first surface 12a′ or on the separate support 37. For this purpose, methods known from the prior art for applying conductor tracks to circuit boards can be used, such as applying electrically conductive coatings and etching away certain regions so that the coating parts remaining on the conductor tracks 40 remain on the substrate or the circuit board 38. So-called printed electronics processes can also be used, according to which conductor tracks 40 can be printed directly onto a substrate using electrically conductive ink. In the course of these processes, some of the sensors 32 can even be printed on and therefore do not have to be applied to the circuit board 12 in a separate assembly process, although this is still possible.

The conductor tracks 40 or lines 36 provided in this way can now be routed to corresponding connection points 42 to which said measurement unit 34 is connected. In the present example, four such connection points 42 are shown. These can also be connected to the measuring unit 34 via a cable harness 44, for example. Alternatively, this cable harness 44 can also be omitted and instead be applied as a conductor track arrangement 46 directly to the top side 12a of the plate 22 or arranged on a support 37 and integrated into the plastic layer 24. The measuring transducer 34 can also provide the measurement signals in a converted form to the connection plug 48. A control device 50 (see FIG. 1) can be connected to this connection plug 48, which evaluates the measurement signals and, based on this, detects, for example, a possible fault in the high-voltage battery 14 and triggers a corresponding measure. The plug 48 can be designed, for example, as an eight-pin plug. This can be covered in the underride guard 12. The measuring transducer 34 can also be referred to as a measuring front end. The gas sensors 32b can be formed by a so-called VOC (volatile organic compound) sensor. The combination sensors 32a can be designed to detect temperature and water or glycol.

Such a plastic plate 22 not only makes it possible to be used at the same time as a circuit board substrate 38 or to be used to integrate sensor lines 36, but also components of the component arrangement 28, in particular lines and/or wires 54 (see FIG. 1) can advantageously be integrated and embedded into the plate 22, which are part of an induction charging coil 56 or represent such a coil and/or are part of or represent a heating wire 58 of a heating device for heating the high-voltage battery 14. The lines 54 can also be arranged and embedded on a support 37, as described for the sensor lines 36. This means that additional functions can be integrated into the underride guard 12 in an advantageous and particularly space-saving manner.

In the example shown in FIG. 2, a deformation and intrusion sensor 32c is shown as a further sensor 32, which includes a laminated resistance wire 52. Such a sensor 32c can now advantageously be laminated directly into the underride guard 12 or into the plate 22. In particular, for example, only the wire 52 can be embedded in the fiber-reinforced plastic 24 of the plate 22 in an unlaminated form or arranged on a corresponding support 37.

In the present example, the underride guard 12 additionally comprises three rails 60, via which the underride guard 12 can be attached to the base 16a of the battery housing 16, and which also have openings to allow gas exchange in and against the y direction, in particular of the harmful gases escaping from the cells 18 in the event of thermal runaway. These rails 60 can be made of a metallic material, for example.

Overall, the examples show how the invention can be used to integrate a sensor cluster in the underride guard. The integration, in particular functional integration, of measurement technology into an underride guard made of a fiber composite material and the measurement of, for example, temperature, humidity, deformation, intrusion and harmful gases has numerous advantages in terms of increasing safety in connection with high-voltage batteries. This can now be implemented in an even more efficient and space-saving manner thanks to the invention and its embodiments. For example, conductor tracks and sensors can be laminated into or applied to the fiber composite plastic component, the underride guard, so that the entire underride guard can function as a huge circuit board, for example. The production of the conductor tracks can be done like a PCB, i.e. a normal circuit board, for example via an etching process of the conductor tracks or by printed conductor tracks on the inside in the underride guard, which is provided by the above-mentioned first side of the underride guard. However, conductor tracks on a support can also be laminated into the underride guard, that is, embedded directly into the fiber composite material. It is particularly advantageous to laminate a wireless charging secondary coil and/or laminate a heating device, for example an underfloor heating or heating elements for battery conditioning. This advantageously eliminates the need for separate cabling, which reduces costs and increases robustness. Overall, a highly integrated sensor set can be provided. This makes it easier to equip the underride guard with sensor sets required depending on the requirements. For example, high-voltage batteries with NMC cells (nickel manganese cobalt battery cells) have different requirements and sensor needs than LFP cells (lithium iron phosphate cells). High-floor vehicles and flat-floor vehicles also have different sensor requirements. Different sensor requirements can now advantageously be implemented in a particularly efficient manner by the underride guard itself.

1. An underride guard for a motor vehicle for arrangement below a high-voltage battery of the motor vehicle, comprising:
a plate-shape,
a first surface,
at least one plastic layer, and
at least one electrical component arrangement which comprises at least one associated electrical line,
wherein the at least one electrical line is arranged on a support and
is embedded in the plastic layer together with the support; or
is arranged on the plastic layer.

2. The underride guard according to claim 1, wherein the support is provided as a substrate which comprises reinforcing fibers, preferably glass fibers, in particular is provided as a reinforcing fiber fleece.

3. The underride guard according to claim 1, wherein the plastic layer represents the support and is designed as a circuit board substrate and the at least one electrical line is applied in the form of at least one conductor track on the first surface of the underride guard provided by the at least one plastic layer; and/or
the at least one electrical line together with the support formed separately from the plastic layer is applied on the first surface of the underride guard provided by the at least one plastic layer.

4. The underride guard according to claim 1, wherein the at least one electrical line is embedded in the at least one plastic layer as part of an induction charging coil included in the component arrangement and/or a heating device.

5. The underride guard according to claim 1, wherein the at least one electrical component arrangement comprises at least one sensor and the at least one conductor track represents a sensor line for conducting measurement signals from the sensor, wherein the sensor line is guided from the sensor to a connection point of the underride guard, in particular wherein the at least one sensor and/or the connection point are arranged on the first surface of the underride guard.

6. The underride guard according to claim 1, wherein the at least one sensor is designed to detect a parameter, a property and/or a defect of the high-voltage battery independently of damage and/or deformation of the underride guard, in particular wherein the at least one sensor represents at least one of the following:
a temperature sensor,
a moisture sensor and/or liquid sensor, and
a harmful gas sensor.

7. The underride guard according to claim 1, wherein the underride guard has a deformation and/or intrusion sensor, with which a second electrical line is associated, which is embedded in the at least one plastic layer.

8. The underride guard according to claim 1, wherein the at least one plastic layer is designed as a fiber-reinforced plastic layer.

9. A motor vehicle having an underride guard according to claim 1.

10. A method for producing an underride guard for a motor vehicle for arrangement below a high-voltage battery of the motor vehicle, wherein the underride guard
is plate-shaped, with a first surface and with at least one plastic layer, and
is designed with at least one electrical component arrangement which comprises at least one associated electrical line,
wherein the at least one electrical line is arranged on a support and is embedded together with the support in the plastic layer or is arranged on the plastic layer.

11. The underride guard according to claim 2, wherein the plastic layer represents the support and is designed as a circuit board substrate and the at least one electrical line is applied in the form of at least one conductor track on the first surface of the underride guard provided by the at least one plastic layer; and/or
the at least one electrical line together with the support formed separately from the plastic layer is applied on the first surface of the underride guard provided by the at least one plastic layer.

12. The underride guard according to claim 2, wherein the at least one electrical line is embedded in the at least one plastic layer as part of an induction charging coil included in the component arrangement and/or a heating device.

13. The underride guard according to claim 3, wherein the at least one electrical line is embedded in the at least one plastic layer as part of an induction charging coil included in the component arrangement and/or a heating device.

14. The underride guard according to claim 2, wherein the at least one electrical component arrangement comprises at least one sensor and the at least one conductor track represents a sensor line for conducting measurement signals from the sensor, wherein the sensor line is guided from the sensor to a connection point of the underride guard, in particular wherein the at least one sensor and/or the connection point are arranged on the first surface of the underride guard.

15. The underride guard according to claim 3, wherein the at least one electrical component arrangement comprises at least one sensor and the at least one conductor track represents a sensor line for conducting measurement signals from the sensor, wherein the sensor line is guided from the sensor to a connection point of the underride guard, in particular wherein the at least one sensor and/or the connection point are arranged on the first surface of the underride guard.

16. The underride guard according to claim 4, wherein the at least one electrical component arrangement comprises at least one sensor and the at least one conductor track represents a sensor line for conducting measurement signals from the sensor, wherein the sensor line is guided from the sensor to a connection point of the underride guard, in particular wherein the at least one sensor and/or the connection point are arranged on the first surface of the underride guard.

17. The underride guard according to claim 2, wherein the at least one sensor is designed to detect a parameter, a property and/or a defect of the high-voltage battery independently of damage and/or deformation of the underride guard, in particular wherein the at least one sensor represents at least one of the following:
a temperature sensor,
a moisture sensor and/or liquid sensor, and
a harmful gas sensor.

18. The underride guard according to claim 3, wherein the at least one sensor is designed to detect a parameter, a property and/or a defect of the high-voltage battery independently of damage and/or deformation of the underride guard, in particular wherein the at least one sensor represents at least one of the following:
a temperature sensor,
a moisture sensor and/or liquid sensor, and
a harmful gas sensor.

19. The underride guard according to claim 4, wherein the at least one sensor is designed to detect a parameter, a property and/or a defect of the high-voltage battery independently of damage and/or deformation of the underride guard, in particular wherein the at least one sensor represents at least one of the following:
a temperature sensor,
a moisture sensor and/or liquid sensor, and
a harmful gas sensor.

20. The underride guard according to claim 5, wherein the at least one sensor is designed to detect a parameter, a property and/or a defect of the high-voltage battery independently of damage and/or deformation of the underride guard, in particular wherein the at least one sensor represents at least one of the following:
a temperature sensor,
a moisture sensor and/or liquid sensor, and
a harmful gas sensor.
